(19) United States
(12) Patent Application Publication
(10) Pub. No.: US 2006/0264334 A1
(43) Pub. Date: Nov. 23, 2006

(54) Non-damaging fracturing fluids and methods for their use

(75) Inventors: D.V. Satyanarayana Gupta, The Woodlands, TX (US); Paul Carman, Spring, TX (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(73) Assignee: BJ Services Company, Houston, TX (US)

(21) Appl. No.: 11/132,112

(22) Filed: May 18, 2005

(51) Int. Cl. C09K 8/62

(52) U.S. Cl. 507/214

(57) ABSTRACT

A non-aqueous well treatment fluid is provided containing a glycol-soluble polymer such as highly substituted hydroxypropyl guar in an alkylene glycol or alkylene glycol ether solvent. A non-aqueous slurry composition for use in preparing water-based well treatment fluids is also provided, having a glycol-soluble polymer such as highly substituted hydroxypropyl guar in an alkylene glycol or alkylene glycol ether solvent. A method is provided for utilizing such a slurry to prepare a water-based well treatment fluid, the method including loading a water-soluble polymer into the slurry, then metering the loaded slurry into water.

### BACKGROUND OF THE INVENTION

The invention relates to fracturing fluids. In one embodiment, a slurry system to suspend a water-soluble polymer including an alkylene glycol or alkylene glycol ether and a hydroxypropyl guar soluble in said glycol or glycol ether is used to prepare a water-based fracturing fluid. In another embodiment, a non-aqueous fracturing fluid is prepared using an alkylene glycol or alkylene glycol ether and hydroxypropyl guar.

Hydraulic fracturing fluids have been used widely in the stimulation of oil and gas wells. Proppant transport and retained conductivity are important qualities of fracturing fluids. Fracturing fluids are typically viscosified with a natural or synthetic polymer to improve the ability of the fluids to transport proppant materials. Water or hydrocarbons have been commonly used as base fluids for fracturing.

Non-aqueous slurries of water-soluble polymers have been used in the industry to meter the polymers into water during the preparation of water-based fracturing fluids. This aids in preparing the water-based fracturing fluids on the fly without the creation of “fish eyes” or micro-gels (i.e. clumped, un-hydrated polymer). The most common non-aqueous base materials used for these slurries are diesel and mineral oil. However, in the North Sea, diesel is often replaced with a synthetic oil such as Biobase because of the North Sea requirement that all additives used in making the fracturing fluid be biodegradable.

Furthermore, in the Gulf of Mexico, it is required that the fracturing fluid meet a specific sheen limitation (i.e. oil is not allowed to float to the surface to create a sheen). For this reason, alkylene glycols have been used as a non-aqueous base material to prepare the non-aqueous slurry. Clays and surfactants are required to stabilize the slurry, although the clays and surfactants are not biodegradable (and therefore cannot be used in North Sea applications). The clays also remain in the hydrated fracturing gel, thereby reducing the conductivity of the proppant pack.

While usually effective, water-based fluids like those described above can be harmful to certain types of formations, and are not effective at removing excess water from a well (i.e. removing “water blocks”). For those situations, other base solvents have been utilized to prepare a fracturing fluid such as diesel or other low molecular weight hydrocarbons. For example, non-aqueous hydrocarbon gels using phosphate esters have been used in water sensitive formations for fracturing applications. However, these systems must be hydrolyzed in order to break them, thereby leaving phosphate residue in the wellbore hydrocarbons that has been shown to foul and scale refineries. Alternatively, 100% methanol and other alcohols have been utilized to prepare fracturing fluids for formations that are not compatible with hydrocarbons or water. Advantages of alcohols over water-based fluids include low freezing points, low surface tensions, high water solubilities, high vapor pressures, and good compatibility with formations. However, alcohols have several potential safety issues relating to their low flash points, high vapor densities, and invisibility of flame.

What is needed is a non-damaging slurry system to be used in preparing a water-based fracturing fluid that is effective, biodegradable, and resists sheen. What is also needed is a non-aqueous fracturing fluid that can be utilized in formations that are not compatible with traditional hydrocarbon solvents or water. The present invention utilizes an alkylene glycol or alkylene glycol ether or derivative viscosified with a polymer to solve both of these problems.

### SUMMARY OF THE INVENTION

A non-aqueous well treatment fluid is provided containing a glycol-soluble polymer in an alkylene glycol solvent. The glycol-soluble polymer can be hydroxypropyl guar, hydroxypropyl cellulose, hydroxyethyl guar, hydroxybutyl guar, or carboxymethylhydroxypropyl guar, but is preferably hydroxypropyl guar having a molar substitution of from about 1.2 to about 2.2. The alkylene glycol solvent can be an alkylene glycol or an alkylene glycol ether or derivative. A crosslinker is included in the well treatment fluid and may consist of including zirconium, titanium, or borate. An enzyme or oxidizing agent may also be used as breaker for the well treatment fluid.

A non-aqueous slurry composition for use in preparing water-based well treatment fluids is also provided, having a glycol-soluble polymer such as highly substituted hydroxypropyl guar in an alkylene glycol solvent. A method is provided for utilizing such a non-aqueous slurry to prepare a water-based well treatment fluid, the method including loading a water-soluble polymer into the non-aqueous slurry, then metering the loaded slurry into water to form the water-based well treatment fluid.

### DESCRIPTION OF THE FIGURES

The following figures form part of the present specification and are included to further demonstrate certain aspects of the present invention. The invention may be better understood by reference to one or more of these figures in combination with the detailed description of specific embodiments presented herein.

| FIG. | Description |
|---|---|
| 1 | Hydration curves for fracturing fluid slurries as described |
| | in Example 1 |
| 2 | Viscosity curve for high pH non-aqueous fracturing fluid |
| | using borate crosslinker as described in Example 2 |
| 3 | Viscosity curve for low pH non-aqueous formulation |
| | using zirconium crosslinker as described in Example 3 |

### DETAILED DESCRIPTION OF THE INVENTION

Compositions

One embodiment of the invention is directed towards a slurry composition for use with a water-based fracturing fluid that includes a polymer soluble in an alkylene glycol solvent (alkylene glycol, alkylene glycol ether, or derivative), a water-soluble polymer not soluble in the alkylene glycol solvent, and the alkylene glycol solvent. Ethylene or propylene glycols or their ethers or other derivatives may be used for this purpose.

The glycol-soluble polymer can generally be any polymer soluble in the alkylene glycol solvent, the alcohol solvent, and mixtures of the alkylene glycol solvent and the alcohol solvent. It is also preferred that the glycol-soluble polymer be a derivative of guar.

The water-soluble polymer may be guar, a derivative of guar, or a derivative of cellulose. It is also preferred that the water-soluble polymer have a hydroxyl, carboxyl, or other group available for crosslinking. Example water-soluble polymers include hydroxypropyl guar, hydroxyethyl cellulose, hydroxypropyl cellulose, hydroxyethyl guar, hydroxybutyl guar, carboxymethylhydroxypropyl guar, and carboxymethyl guar.

The preferred glycol-soluble polymer is hydroxypropyl guar with a molar substitution of about 1.2 to about 2.2. The preparation of a wide array of guar (polygalactomannan) derivatives are described in the scientific literature and in issued patents. For example, U.S. Pat. Nos. 3,723,408; 3,723,409; 4,169,945; 4,276,414; 4,094,795; 3,346,555; 3,303,184; 3,255,028; and 4,031,306 detail the synthesis of derivatives such as allyl ether, aminoethyl, acrylamide, dialkylacrylamide ether, zwitterion, alkyl ether, carboxyalkyl hydroxyalkyl, and hydroxyalkyl ether derivatives. The preparation of hydroxypropyl guar in particular is described in U.S. Pat. No. 3,723,408, which is incorporated herein by reference in its entirety. Guar is reacted with propylene oxide in the presence of base to prepare hydroxypropyl guar. As used herein, molar substitution is the number of moles of hydroxypropyl groups per mole of polymer. By varying the molar ratio of propylene oxide to guar, polymers of different molar substitution can be obtained.

Another embodiment of the invention is directed towards a non-aqueous fracturing fluid for use in water-sensitive formations including a polymer, an alkylene glycol solvent (alkylene glycol, alkylene glycol ether, or derivative), an alcohol solvent, a crosslinker, and a breaker. As with the slurry composition above, ethylene or propylene glycols or their ethers may be used for this purpose.

The polymer can generally be any polymer soluble in the alkylene glycol solvent, the alcohol solvent, and mixtures of the alkylene glycol solvent and the alcohol solvent. It is also preferred that the polymer have a hydroxy, carboxy, or other group available for crosslinking. Example polymers include hydroxypropyl guar, hydroxypropyl cellulose, hydroxyethyl guar, hydroxybutyl guar, and carboxymethylhydroxypropyl guar. As discussed above with respect to the slurry composition, the preferred polymer is: hydroxypropyl guar with a molar substitution of about 1.2 to about 2.2.

The alcohol solvent can generally be any alcohol solvent in which the polymer can dissolve. It is also advantageous if water is soluble in the alcohol. Example alcohol solvents include methanol, ethanol, 2-propanol (isopropyl alcohol), 1-butanol, and 2-butanol.

The crosslinker can generally be any crosslinker functional to crosslink the polymer. For example, for hydroxypropyl guar, the hydroxypropyl guar's hydroxy groups, the crosslinker can be a zirconium salt crosslinker or a titanium salt crosslinker, such as oxychloride, acetate, tetrachloride, O-sulfate or carbonate, or chelated titanium or zirconium compounds, for example, with lactate, citrate, triethanolamine, hydroxyethyl glycine or any titanium or zirconium oxides such as zirconium isopropoxide or zirconium isobutoxide. The zirconium salt or titanium salt crosslinkers include any zirconium salt or titanium salt soluble in alcohol or chelated zirconium or titanium compound, generally known in the industry. Hydroxypropyl guar may also be a crosslinked with borates such as monoborates, borate esters, and polyborates.

The breaker can generally be any breaker functional to degrade the polymer under downhole conditions. The breaker can generally be any oxidizing agent or encapsulated oxidizing agent. For example, the breaker can be a percarbonate, a perchlorate, a peracid, a peroxide, or a persulfate. The breaker can be encapsulated or unencapsulated. As an alternative to encapsulation, a low solubility breaker can be used. Specific examples of breakers include sodium persulfate and encapsulated potassium persulfate.

The non-aqueous fracturing fluid composition can further comprise a proppant. The proppant can generally be any proppant, such as sand, ceramic particles, or resin coated particles.

Methods of Use

The above-described compositions can be used in conjunction with treating a downhole well formation. Accordingly, an additional embodiment of the invention is directed towards methods for fracturing a downhole well formation.

One preferred method of the present invention includes preparing a water-based fracturing fluid by metering the above-described non-aqueous slurry composition into water. As described above, the slurry composition comprises a glycol-soluble polymer, such as hydroxypropyl guar polymer with a molar substitution of about 1.2 to about 2.2, that is used to viscosify the alkylene glycol solvent and to suspend the water-soluble polymer. The glycol-soluble polymer concentration in the non-aqueous slurry is between about 10 pounds to about 100 pounds per thousand gallons, and preferably between about 20 pounds to about 75 pounds per thousand gallons. The water-soluble polymer is then added to the glycol slurry the loaded slurry in a concentration of between about 2 pounds and 6 about pounds per gallon, and preferably about 4 pounds per gallon. Because of the use of hydroxypropyl guar as the glycol-based polymer, clays and surfactants are not required to stabilize the slurry, thereby eliminating the conductivity problems associated with prior uses of alkylene glycol solvents as a slurry solvent.

The loaded slurry (containing both the glycol-soluble and water-soluble polymers) is then metered into water, preferably at a loading of between about 5 gallons to about 10 gallons of slurry in about 1000 gallons of water, and most preferably at a loading of about 7.5 gallons of slurry in about 1000 gallons of water. After full hydration of the slurry in the water solvent, the resulting fracturing fluid can be crosslinked with zirconium or borate crosslinkers commonly used with water-based systems. In addition, the glycol-soluble polymer (hydroxypropyl guar polymer with a molar substitution of about 1.2 to 2.2) can also be crosslinked because of the hydroxypropyl guar's hydroxy groups. Conventional breakers, such as enzymes or oxidizers, can be used with the water-based fracturing fluid to break the glycol-soluble polymer and the water-soluble polymer after the fracturing treatment is completed. Once prepared, the water-based fracturing fluid of the present invention can be pumped into the wellbore, thereby contacting and fracturing the formation.

The slurry can be prepared in a chemical plant at a remote location and is transported to the field location where the well site is located. Accordingly, the slurry must be stable as it may be days or weeks before the slurry is actually used in a well. At the well site location, the actual fracturing fluid is prepared by adding the slurry to water to hydrate the water-soluble polymer. Additional surfactants may be added to the slurry, if needed to disperse the water-soluble polymer in the slurry.

Another preferred method of the present invention is directed towards preparing and using a non-aqueous fracturing fluid using the above-described composition. The non-aqueous fracturing fluid can be prepared having a hydroxypropyl guar polymer with a molar substitution of about 1.2 to about 2.2, an alkylene glycol solvent (alkylene glycol, alkylene glycol ether, or derivative), an alcohol solvent, a buffer, a crosslinker, and a breaker. Because the alkylene glycol solvent is viscosified with the hydroxypropyl guar, the resulting fracturing fluid can be crosslinked with zirconium or borate crosslinkers commonly used with water-based systems because of the hydroxypropyl guar's hydroxy groups at an appropriate equivalent pH (non-aqueous solutions do not have pH). Conventional breakers, such as enzymes or oxidizers, can be used with the fracturing fluid to break the hydroxypropyl guar after the fracturing treatment is completed. Once prepared, the non-aqueous fracturing fluid of the present invention can be pumped into the wellbore, thereby contacting and fracturing the formation. Additionally, surfactants may be added to prevent emulsion formation of the broken fracturing fluid with formation fluids (such as hydrocarbons) or to lower the surface tension so that the broken fluid can be recovered easily from the wellbore to the surface. Proppants may also be added to the fluid to help the created fracture open for long-term fracture effectiveness.

It is also a preferred aspect of the present invention that the crosslinked non-aqueous fracturing fluid prepared with hydroxypropyl guar in an alkylene glycol solvent is also compatible with and can be used with carbon dioxide for underpressured wells. This application is described further in pending U.S. patent application Ser. No. 10/267,686, which is incorporated herein by reference in its entirety. This fracturing fluid system can also be as a carbon dioxide miscible fracturing fluid as is described in SPE 75666 and U.S. Pat. No. 5,674,816, which are both incorporated herein by reference in their entireties.

The method also includes removing the fracturing fluid from the formation after the contacting step. This removing step can be aided by gas pressure created by the addition of carbon dioxide or nitrogen. The hydroxypropyl guar can be broken with oxidizers or enzymes and the alkylene glycol or alkylene glycol ether solvent can be separated and recycled from the formation hydrocarbons, thereby making the system more cost effective than prior art non-aqueous fracturing fluid systems. Methods for recycling fracturing fluids in such a manner is discussed in more detail in U.S. Pat. No. 6,875,728, which is incorporated herein by reference in its entirety.

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Example 1

### Preparation of a Slurry Composition for Use with Water-Based Fracturing Fluids

The slurry was prepared by adding 20 to 75 pounds of the highly substituted hydroxypropyl guar (GM-60, BJ Services Company, Houston, Tex.) per thousand gallons and 2 pounds of fumaric acid per thousand gallons in glycol ether (propylene glycol monomethyl ether, Arcosolv PM, Lyondell Chemical, Houston, Tex.). After the glycol ether is viscosified, 4 pounds per gallon of a water-soluble standard guar (GW-4, BJ Services Company, Houston, Tex.) is added. This polymer slurry is added to water at a loading of 7.5 gallons of slurry to 1000 gallons of water and allowed to hydrate under constant mixing for one hour. One (1) to five (5) gallons of an ethoxylated alcohol per thousand gallons was then added to the slurry to aid in water-soluble polymer dispersion and hydration upon contact with water.

Depending on the concentration of the GM-60, the viscosity of the slurry ranged from 100 cP to 350 cP at 511s-1, which is comparable to most diesel-based slurries. The slurry stability also depended on the concentration of GM-60 and ranged from 1% vol. to 20% vol. free solvent after 24 hours. As shown in FIG. 3, the hydration of the slurry in water and 2% wt. KCI are very similar to other diesel and environmentally friendly slurries. GW-4AFG is a guar polymer of a specific mesh size available from BJ Services of Tomball, Tex. BioBase 637, a biodegradable synthetic oil typically used today for slurries of this type, is an alpha olefin available from Shrieve Chemical Products of The Woodlands, Tex. The slurry prepared with Cellosolv (i.e. ethylene glycol monoethyl ether) also demonstrates similar hydration to the slurry prepared with Arcosolv PM (i.e. propyleneglycol monomethyl ether). FIG. 3 shows the hydration curves for these various slurries.

### Example 2

### Preparation of a High pH Non-Aqueous Fracturing Fluid Using Borate Crosslinker

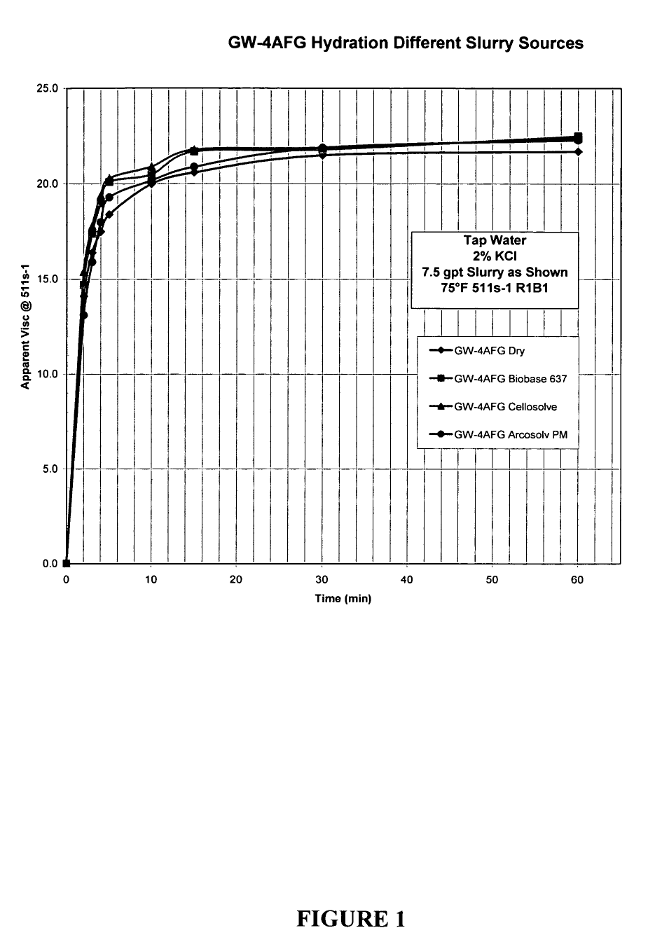

The base solvent was prepared as a blend of 87.5% vol. glycol ether (Cellosolv, Fisher Scientific) and 12.5% vol. methanol (technical grade, Fisher Scientific). Since most buffers used to adjust the pH are not soluble in glycol ethers, the addition of methanol makes the buffers compatible with the glycol ether. Highly substituted hydroxypropyl guar (GM-60) was added to the base solvent at a loading of 50 pounds per thousand gallons along with 2 pounds per thousand gallons fumaric acid to aid in hydration. The polymer was allowed to hydrate for 60 minutes with continuous agitation. One (1) gallon of CXB-10 (BJ Services), a combined borate crosslinker/pH adjuster having 2.7% boron, per thousand gallons was added to the hydrated polymer solution, resulting in an equivalent pH of 10.2. The resultant crosslinked gel was evaluated in a HPHT rheometer (FANN 50c) at a nitrogen pressure of 400 psi. The crosslinked gel was heated to 150° F. at continuous shear of 100 sec-1. FIG. 1 displays the results, which has a viscosity of about 350 cP at 120 minutes. It is understood to those skilled in the art in the industry that a minimum viscosity is needed for fracturing the formation and transporting the proppant to the fracture. This can be between 10 cP to 100 cP depending on the formation and the proppant. Thus, the fluid with the viscosity displayed in FIG. 1 can easily be used as a fracturing fluid for at least 2 hours.

### Example 3

### Preparation of a Low pH Non-Aqueous Formulation Using Zirconium Crosslinker

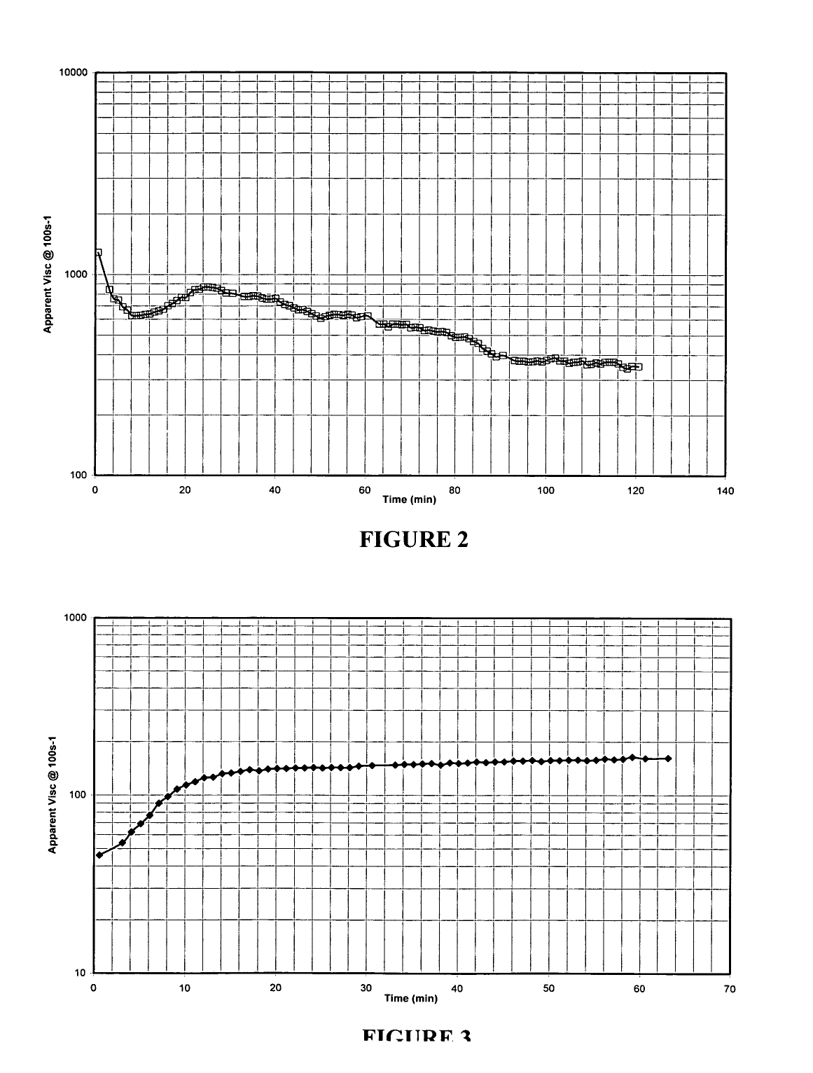

The base solvent was prepared as a blend of 87.5% vol. glycol ether (Arcosolv PM, Lyondell Chemical) and 12.5% vol. methanol (technical grade, Fisher Scientific). Highly substituted hydroxypropyl guar (GM-60) was added to the base solvent at a loading of 50 pounds per thousand gallons along with 2 pounds per thousand gallons fumaric acid to aid in hydration. The polymer was allowed to hydrate for 60 minutes with continuous agitation. Three (3) gallons of 90% wt. Formic acid per thousand gallons was added to the hydrated polymer solution, resulting in an equivalent pH of 3.8. Next, two (2) gallons XLW-12 (BJ Services), a zirconium crosslinker containing 6% Zr, per thousand gallons was added. The resultant crosslinked gel was evaluated in a HPHT rheometer (FANN 50c) at a nitrogen pressure of 400 psi. The crosslinked gel was heated to 200° F. at continuous shear of 100 sec-1. FIG. 2 displays the results, which has a viscosity of about 160 cP at 120 minutes. As described before, this fluid has enough viscosity to be useful as fracturing fluid at this temperature condition for at least 2 hours.

It is well known in the industry that certain formations are compatible with high pH fluids and certain others are compatible with low pH fluids. For example, if the formation that is fractured contains a significant amount of clays, low pH fluids are preferred to prevent clay swelling and clay migration that can damage the fracture conductivity. In underpressured reservoirs, nitrogen or carbon dioxide is used with the fracturing fluid to help in recovery of the broken fracturing fluid after the fracturing operation is completed. Carbon dioxide is soluble in the base fluid and tends to form carbonic acid that results in a low pH. Carbon dioxide, thus, is not compatible with high pH fluids. If it is desired to use carbon dioxide as the energizing medium, it is necessary to formulate the fracturing fluid at low pH. These tests show that the system is versatile enough to be used either for high pH (Example 2) or low pH (Example 3) applications.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the methods described herein without departing from the concept, spirit and scope of the invention. More specifically, it will be apparent that certain agents which are chemically related may be substituted for the agents described herein while the same or similar results would be achieved. All such similar substitutes and modifications apparent to those skilled in the art are deemed to be within the scope and concept of the invention.

What is claimed is:

1. A composition for use in treating wellbore formations, comprising:
a polymer; and
an alkylene glycol solvent;
wherein the polymer is soluble in the alkylene glycol solvent.

2. The composition of claim 1, wherein the polymer is hydroxypropyl guar, hydroxypropyl cellulose, hydroxyethyl guar, hydroxybutyl guar, or carboxymethylhydroxypropyl guar.

3. The composition of claim 2 wherein the hydroxypropyl guar has a molar substitution of from about 1.2 to about 2.2.

4. The composition of claim 1, wherein the alkylene glycol solvent is an alkylene glycol or an alkylene glycol ether or derivative.

5. The composition of claim 1, wherein the alkylene glycol solvent is ethylene glycol, ethylene glycol ether, propylene glycol, or propylene glycol ether.

6. A non-aqueous well treatment fluid composition, comprising:
a polymer;
an alkylene glycol solvent;
a crosslinker; and
a breaker
wherein the polymer is soluble in the alkylene glycol solvent.

7. The composition of claim 6, wherein the polymer is hydroxypropyl guar, hydroxypropyl cellulose, hydroxyethyl guar, hydroxybutyl guar, or carboxymethylhydroxypropyl guar.

8. The composition of claim 7 wherein the hydroxypropyl guar has a molar substitution of from about 1.2 to about 2.2.

9. The composition of claim 6, wherein the alkylene glycol solvent is an alkylene glycol or an alkylene glycol ether or derivative.

10. The composition of claim 6, wherein the alkylene glycol solvent is ethylene glycol, ethylene glycol ether, propylene glycol, or propylene glycol ether.

11. The composition of claim 6, further comprising an alcohol solvent, wherein the polymer is soluble in the alcohol solvent.

12. The composition of claim 11, wherein the alcohol solvent is methanol, ethanol, 2-propanol, 1-butanol, or 2-butanol.

13. The composition of claim 6, wherein the crosslinker comprises zirconium, titanium, or borate.

14. The composition of claim 13, wherein the borate is a monoborate, a borate ester, or a polyborate.

15. The composition of claim 6, wherein the breaker comprises an oxidizing agent.

16. The composition of claim 15, wherein the oxidizing agent is a percarbonate, a perchlorate, a peracid, a peroxide, or a persulfate.

17. The composition of claim 6, wherein the breaker comprises an enzyme.

18. A slurry composition for use in the preparation of water-based well treatment fluids, comprising:
a polymer; and
an alkylene glycol solvent,
wherein the polymer is soluble in the alkylene glycol solvent, and

19. The composition of claim 18, wherein the slurry composition contains from about 2% vol. to about 10% vol. free solvent.

20. The composition of claim 18, wherein the viscosity of the slurry composition is. from about 100 cP to about 350 cP at 511 sec⁻¹.

21. The composition of claim 18, wherein the polymer is hydroxypropyl guar, hydroxypropyl cellulose, hydroxyethyl guar, hydroxybutyl guar, or carboxymethylhydroxypropyl guar.

22. The composition of claim 21 wherein the hydroxypropyl guar has a molar substitution of from about 1.2 to about 2.2.

23. The composition of claim 18, wherein the alkylene glycol solvent is an alkylene glycol ether or derivative.

24. The composition of claim 18, wherein the alkylene glycol solvent is ethylene glycol, ethylene glycol ether, propylene glycol, or propylene glycol ether.

25. A method for preparing a water-based well treatment fluid, comprising:
providing a non-aqueous slurry comprising:
a polymer; and
an alkylene glycol solvent,
wherein the polymer is soluble in the alkylene glycol solvent;
adding a water-soluble polymer to the non-aqueous slurry to form a loaded slurry; and
metering the loaded slurry into water to form the water-based well treatment fluid.

26. The method of claim 25, wherein the polymer is hydroxypropyl guar, hydroxypropyl cellulose, hydroxyethyl guar, hydroxybutyl guar, or carboxymethylhydroxypropyl guar.

27. The method of claim 26 wherein the hydroxypropyl guar has a molar substitution of from about 1.2 to about 2.2.

28. The method of claim 25, wherein the alkylene glycol solvent is an alkylene glycol or an alkylene glycol ether or derivative.

29. The method of claim 25, wherein the alkylene glycol solvent is ethylene glycol, ethylene glycol ether, propylene glycol, or propylene glycol ether.

30. The method of claim 25, wherein the polymer concentration in the non-aqueous slurry is between about 10 pounds to about 100 pounds per thousand gallons.

31. The method of claim 25, wherein the polymer concentration in the non-aqueous slurry is between about 20 pounds to about 75 pounds per thousand gallons.

32. The method of claim 25, wherein the water-soluble polymer concentration in the loaded slurry is between about 2 pounds and 6 about pounds per gallon.

33. The method of claim 25, wherein the water-soluble polymer concentration in the loaded slurry is about 4 pounds per gallon.

34. The method of claim 25, wherein the loaded slurry is metered into water at a loading of between about 5 gallons to about 10 gallons of slurry in about 1000 gallons of water.

35. The method of claim 25, wherein the loaded slurry is metered into water at a loading of about 7.5 gallons of slurry in about 1000 gallons of water.

36. The method of claim 25, further comprising adding an alcohol to the loaded slurry to aid in dispersing the water-soluble polymer in the non-aqueous slurry.

37. The method of claim 36, wherein the alcohol is an ethoxylated alcohol.

38. The method of claim 36, wherein the alcohol concentration in the loaded slurry is between about 0.1% to about 1.0% by volume.

39. The method of claim 25, wherein the slurry composition contains from about 2% vol. to about 10% vol. free solvent.

40. The method of claim 25, wherein the viscosity of the non-aqueous slurry has a viscosity in the range of from about 100 cP to about 350 cP at 511s-1.
